(19) United States
(12) Patent Application Publication
(10) Pub. No.: US 2022/0374959 A1
(43) Pub. Date: Nov. 24, 2022

(54) ACQUIRING AND UTILIZING INDIVIDUAL STYLE PROFILES FOR ONLINE GIFT SHOPPING

(71) Applicant: CurioSearch DBA Materiall, Milpitas, CA (US)

(72) Inventor: Karpagam Gobalakrishna, PLEASANTON, CA (US)

(73) Assignee: CurioSearch DBA Materiall, Milpitas, CA (US)

(21) Appl. No.: 17/308,247

(22) Filed: May 5, 2021

(51) Int. Cl. G06Q 30/06; G06Q 30/02

(52) U.S. Cl. CPC G06Q 30/0631; G06Q 30/0621; G06Q 30/0203; G06Q 30/0633

(57) ABSTRACT

Disclosed herein is a computer implemented method of acquiring and utilizing individual style profiles for online gift shopping for a gift recipient and a gift buyer on a ecommerce website. Deep attribute and aesthetic level preferences of the gift recipient are captured via an interactive engagement module. The gift recipient is exposed to both visual and textual questions. The deep attribute and aesthetic level preferences of the gift recipient are applied to surface products for purchase by said gift buyer. When the gift buyer sets a budget, the preferences of the gift recipient's surface products for purchase by the gift buyer within said budget. When a group of gift recipients are considered, an integrated style profile is created and conflicts are resolved.

### BACKGROUND

This invention in general relates to ecommerce, and specifically relates to a method and system of for online gift shopping.

A significant part of online purchases entails purchasing gifts for others. It is essential that the gift purchaser accurately understands the preferences of the gift recipient. Even if the gift recipient is well known to the gift buyer, the product or service preferences of the gift recipient cannot be assumed to be obvious.

In the current ecommerce industry, about 10% of online purchases are returned. In the case of gift purchases, the percentage of returns is even higher. Currently, approximately 40% to 60% of shoppers buy gifts online. If the gift is an improper fit, it is socially well accepted to have the gift replaced with another of equivalent dollar value. Given the low profit margins in online retail, it is essential that this return percentage is reduced to positively impact the bottom line of the ecommerce industry.

Another issue with gifting is the predicament of the gift recipient in receiving a less worthy gift that does not fit their functional requirements and aesthetic preferences.

There is an unmet need to enable gift buyers to determine the deep preferences of the gift recipient, and thereby increase product or service acceptance and reduce returns.

In the current art, preferences are typically captured for gift buyers at a category or class level. Gift registries exist that expose the wish list of gift recipients. The challenge of purchasing gifts under such categories or classes of product/services is that it does not capture the deep attribute or aesthetic preferences of the gift recipient, and the element of “pleasant surprise” when receiving a non obvious gift is taken away from the gifting experience. Even in the before mentioned product classes and wish lists, quantized numeric ranking requests are presented to the gift recipient to build their profile. Such rankings do not capture hidden and implicit deep preferences of gift recipients.

### SUMMARY OF THE INVENTION

Disclosed herein is a computer implemented method of acquiring and utilizing individual style profiles for online gift shopping for a gift recipient(s) and a gift buyer on a ecommerce website. The aforementioned method and system overcomes the drawback of the coarse level approach of classes, categories and wish lists discussed in the earlier section.

In one aspect of the invention, deep attribute and aesthetic level preferences of the gift recipient are captured via an interactive engagement module. The gift recipient is exposed to both visual and textual questions. The deep attribute and aesthetic level preferences of the gift recipient are applied to surface products for purchase by the gift buyer.

In another aspect of the invention, when the gift buyer sets a budget, the preferences of the gift recipient's surface products for purchase by the gift buyer within the budget.

In a further aspect of the invention, when a group of gift recipients are considered, an integrated style profile is created based on the identified commonalities at an attribute level and the derived insights are created for use in the current session of the gift buyer. If there is a conflict in preferences of the plurality of gift recipients, reconciliation is undertaken.

The reconciliation is effected by the gift buyer overriding conflicting interests by choosing one or a combination of preferences of the gift recipients. The reconciliation is also effected by the gift buyer exposing the conflict to the gift recipients, and the conflict is resolved collectively by the gift recipients.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer implemented method of acquiring and utilizing individual style profiles for online gift shopping for a gift recipient by a gift buyer on a ecommerce website. The computer implemented method of acquiring also includes capturing deep attribute and aesthetic level preferences of said gift recipient via an interactive engagement module, where said gift recipient is exposed to both visual and textual questions; and applying said deep attribute and aesthetic level preferences of the gift recipient to surface products for purchase by said gift buyer. Other embodiments of this aspect include corresponding computer systems, apparatus, and computer programs recorded on one or more computer storage devices, each configured to perform the actions of the methods.

Implementations may include one or more of the following features. The computer implemented method where said gift buyer sets a budget, and said deep attribute and aesthetic level preferences of the gift recipient's surface products for purchase by the gift buyer within said budget. Said gift buyer enters the ecommerce website and initiates the creation of a custom profile for the gift recipient and an invitation link is thereafter sent to the gift recipient. Said ecommerce website will provide tabs for profile capture initiation for the gift recipient. The gift recipient may disengage at any point during their profile building process. After said gift recipient disengages in said profile building process, a pop up is generated that states that a style profile has been generated for the gift recipient and confirms with the gift recipient whether the style profile can be shared with the gift buyer. The gift buyer will have an option to view the profile on the website and have the option to use the profile for a one time use and define the time period to retain the profile. The style profile of the gift recipient is segmented, and the gift recipient selectively shares only certain segments of their profile. When the gift recipient's profile is on active mode, product or service options presented for purchase on the website will lean towards the preferences of the gift recipient, and if the gift recipient's profile is deactivated, the personal preferences of the gift buyer will be activated. A privacy filter is set up by said gift recipient enabling them to browse in incognito mode without enabling recording of their profile during selected sessions and where the act of selection of said incognito mode will not make changes to their profile during said selected sessions. Said gift recipient selectively deselects certain historical sessions from their profile. Said gift recipient may create a profile and share it selectively with others, and can optionally set up a time for deactivation of a profile of said gift recipient. Implementations of the described techniques may include hardware, a method or process, or computer software on a computer-accessible medium.

One general aspect includes a computer implemented method of acquiring and utilizing individual style profiles for online gift shopping for a plurality of gift recipient's by a gift buyer transacting on a ecommerce website. The computer implemented method of acquiring also includes capturing deep attribute and aesthetic level preferences of the plurality of said gift recipients via an interactive engagement module, where said gift recipient is exposed to both visual and textual questions; and creating an integrated style profile based on the identified commonalities at an attribute level and the derived insights is created for use in the current session of the gift buyer, and applying said integrated style profile of the gift recipients to surface products for purchase by said gift buyer. Other embodiments of this aspect include corresponding computer systems, apparatus, and computer programs recorded on one or more computer storage devices, each configured to perform the actions of the methods.

Implementations may include one or more of the following features. The computer implemented method where a call to action is presented to the gift buyer to capture the use of the profile of one or more gift recipients. If there is a conflict in preferences of the plurality of gift recipients, reconciliation is undertaken. Said reconciliation is effected by the gift buyer overriding conflicting interests, and choosing one or a combination of preferences of the gift recipients. The reconciliation is effected by the gift buyer exposing said conflict to the gift recipients, and the conflict is resolved collectively by the gift recipients. Said integrated style profile is a linked profile of gift recipients in close social standing and where tastes and preferences of the gift recipients are dynamically updated in said integrated style profile. Implementations of the described techniques may include hardware, a method or process, or computer software on a computer-accessible medium.

One general aspect includes a system for acquiring and utilizing individual style profiles for online gift shopping for a multiplicity of gift recipients by a gift buyer on an ecommerce website. The system also includes at least one processor; a non-transitory computer readable storage medium communicatively coupled to said at least one processor, said non-transitory computer readable storage medium configured to store modules, said at least one processor configured to execute said modules; and said modules may include: a call to action module for generating prompts for said gift recipients to include one more other gift recipients; a conflict resolution module for resolving contradictions between preferences of gift recipients; a collective preferences modules module for analysing custom profiles of each of said plurality of gift recipients; a style machine module that records each of said plurality of gift recipients' analysed style profiles, and creates an integrated style profile of the plurality of gift recipients; and a recommendation engine for generating and presenting the curated product to be displayed to said gift buyer based on said integrated style profile. Other embodiments of this aspect include corresponding computer systems, apparatus, and computer programs recorded on one or more computer storage devices, each configured to perform the actions of the methods.

Implementations may include one or more of the following features. The system where said resolving contradictions is effected by the gift buyer exposing conflict to the gift recipients, and said conflict is resolved collectively by the gift recipients. Implementations of the described techniques may include hardware, a method or process, or computer software on a computer-accessible medium.

### BRIEF DESCRIPTION OF FIGURES

FIG. 1 illustrates an example method of acquiring and utilizing individual style profiles for online gift shopping for a gift recipient.

FIG. 2 illustrates an example method of acquiring and utilizing individual style profiles for online gift shopping for a plurality of gift recipients.

FIG. 3 illustrates a system for acquiring and utilizing individual style profiles for online gift shopping.

FIG. 4 illustrates an overall system architecture for determining the product and service preferences of a gift recipient.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

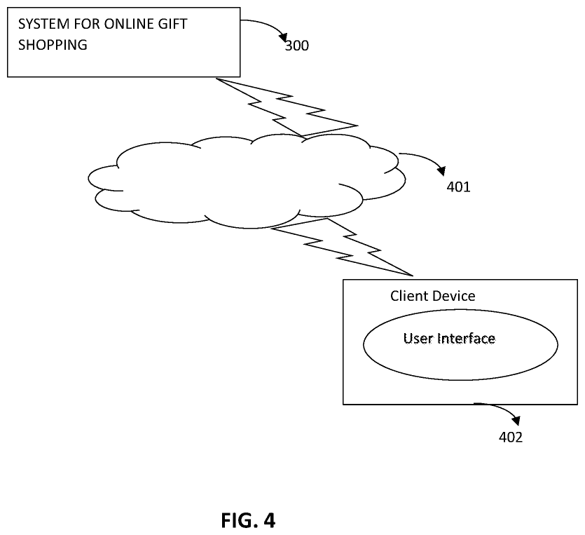

The setup includes a system for online gift shopping 300. The system illustrated in FIG. 4 may include one or a plurality of servers deployed at a single location, or distributed geographically. For example, in one embodiment the online gift shopping 300 may be deployed on a cloud-based system 401. The online gift shopping 300 includes modules, databases, computing resources etc. necessary to implement the techniques of collective preference generation disclosed herein, as one of ordinary skill in the art would understand.

A client device 402 may take various forms, such as my smart phone, a tablet device, a PC, a laptop, etc. for the purposes of description, the client device 402 comprises a smart phone. Among other components, the smart phone 402 may be equipped with a user interface agent, which may take the form of a web browser. A smart phone 402 may be communicatively coupled to the system for online gift shopping by means of an intermediate wide area network. In one embodiment, the intermediate wide area network may represent various technologies including Internet, and wireless networking technologies. For example, using a smart phone, the user may launch a “buy gift” application provisioned in the smart phone.

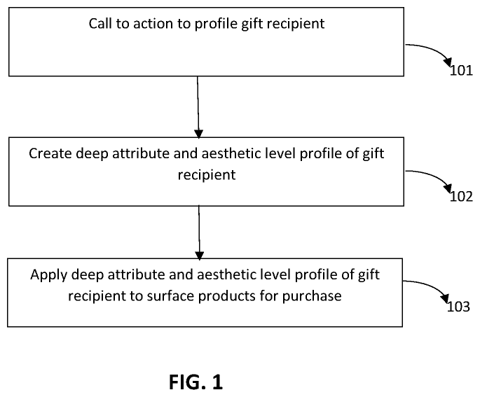

FIG. 1 illustrates the method of acquiring and utilizing individual style profiles for online gift shopping for a gift recipient. The gift buyer initiates the creation of a custom profile for the gift recipient on the ecommerce website. The ecommerce website will provide tabs for call to action 101 for profile capture initiation, and will request inputs for the name, email address, or other form of contact information of the gift recipient. The ecommerce website will then create an invitation link for the gift recipient. The link can be sent from the website, or it can be copied and sent via email or any other social media channel from the communication and transaction device of the gift buyer.

Once the gift recipient receives the link, for example consider the case when Emma, the gift buyer has generated an invite for Henry, the gift recipient. The email generated will for example state “Hey Henry, Emma wants to know your style profile, would you be interested in filling a short questionnaire to send her your style profile”. When Henry accepts the request, Henry is taken to the section of the ecommerce website where the invitation was generated.

The gift recipient will have the option to continue with the profiling process in the role as a guest, or can sign in for a new account. If the gift recipient signs in for a new account, his or her style profile will be captured and stored in their account. In the journey of capturing the style profile of the gift recipient, the gift recipient will be exposed to both visual and textual questions. Predominantly, the questions will be visual, however a few textual questions will be posed to capture personal information, for example gender and age.

In an embodiment, an Interactive Engagement Module 305 will engage the user to provide an input on the images presented to them. The Interactive Engagement Module is utilized to understand the user preferences at a deeper attribute level by engaging with the gift recipient in real time in a non-transactional and non-intrusive manner 102.

The online ecosystem could be either an e-commerce site or a website/webpage with no transactions involved. The gift entities could be any article that has a plurality of attributes, for example, clothing, books, movies, and employees. The Interactive Engagement Module is exposed in an engaging way to the gift recipient only when the gift recipient indicates a subtle or open interest in the entity shown either by hovering or clicking. The gift recipient has complete control over their choice to either engage or not engage with the Interactive Engagement Module (IEM). The specific attributes to be used in the IEM from the list of attributes for any entity is chosen by the owner of the ecommerce ecosystem based on what they want to understand about their audience or the entity.

During the gift recipient's journey for preference capture, when the gift recipient expresses subtle interest in an entity among multiple entities by hovering over it, the IEM gets exposed in an engaging, non-intrusive manner either over or below the image of the entity for the gift recipient to optionally engage with. Alternatively, the IEM is exposed either over or below the image of the entity when the gift recipient actively clicks a button denoting open interest in engaging with the module.

The gift recipient may like or not like a specific attribute, and such a preference will be captured by the interactive engagement module. For example, the gift recipient may like a specific, pattern or colour, and this information is captured. For example, the gift recipient may be presented with 12 to 24 images, and the gift recipient may choose to engage or not engage.

The gift recipient may disengage at any point in the profile building process. Once the user disengages, a pop up is generated that states that a style profile has been generated for the gift recipient, and confirms with the gift recipient whether the style profile can be shared. Reverting to the earlier example, a pop up will ask Henry if his style profile can be sent to Emma. When Henry accepts the share request, his style profile reaches Emma by email as well as gets stored in the website for access by Emma.

The gift buyer may be provided with an intimation by email that the gift recipient has filled his or her profile and that their profile is now ready for use for a gift purchase. The gift buyer may be provided with an option to view the profile on the website and have the option to use the profile for a one time use or can define as to how long they wish to retain the profile. For example, if Henry is getting married in six months, Emma can maintain his profile with the wedding date as the end date for storage of his profile; prior to which she may act on purchasing gifts for Henry based on his profile.

The style profile can be segmented, and the gift recipient may have an option to selectively share only certain segments of their profile. When Henry creates an account, he is aware of whom his style profile is shared with, and any point in time, Henry is provided with an option to edit or delete part/segments or whole of his profile. For example, if at any point in time Henry is “unfriending” a person or does not wish to interact with that person, Henry can selectively disable the use of his style profile.

At block 103, deep attribute and aesthetic level profile of gift recipient is utilized—to surface products for purchase.

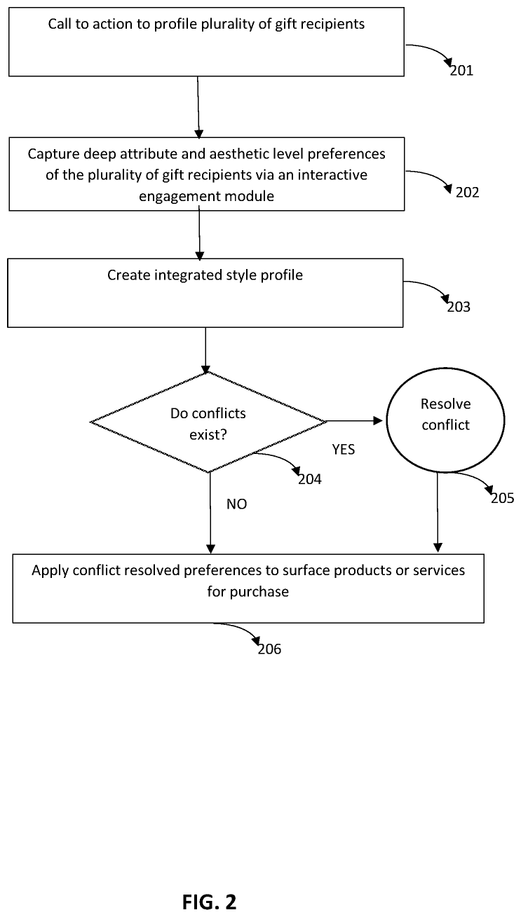

FIG. 2 illustrates the method of acquiring and utilizing individual style profiles for online gift shopping for a plurality of gift recipients. In an embodiment, the gift buyer can generate style profiles for not just one, but for a plurality of gift buyers, for example a family or a set of best friends.

A call to action (CTA) module is presented to the gift buyer 201 to capture the use of the profile of one or more gift recipients. After the style profile of the first gift recipient is generated, the CTA module is again initiated for the rest of the gift recipients, and a confirmation prompt is generated to create 202 an integrated style profile for use in the current session of the gift buyer. The CTA module presents the gift buyer with a choice to confirm that if both a first gift recipient and a second gift recipient's style profile can be collectively used, and if any gift recipient's style preferences need to be added. Hence, a collective set of preferences are utilized.

Once the CTA module receives the confirmation on the number of profiles to be collectively used, the computation module runs the algorithm to analyse the style profile of the first and second gift recipient, or a plurality of gift recipients, and creates a new integrated style profile 203 based on the identified commonalities at an attribute level and the derived insights.

For example, if the first gift recipient shows a preference to the colour red, and the second gift recipient shows a preference to the colour yellow. A recommendation engine 304 then infers that the first and second gift recipients have an inclination towards a spectrum of warm colours such as shades of orange, yellow and red. Considering another example, if the first user prefers red, and the second user prefers green, the recommendation engine infers that they like may prefer contrasting or complementing colours instead of a choice of a single colour.

When the gift buyer is about to start exploring products to gift, he or she will visit their settings and select the gift recipient's profile. A pop up will be generated on the website identifying the profile that is being used. When the gift recipient's profile is on active mode, product or service options presented for purchase on the website will lean towards the preferences of the gift recipient. If the gift recipient's profile is deactivated, the personal preferences of the gift buyer will be activated.

Multiple profiles may be stored in a single account of a gift buyer. Optionally, the gift buyer may choose either one or a multiplicity of profiles in the purchasing process. For example, the buyer may choose the style profiles his or her entire family for the purchase of a certain product. Hence, an integrated style profile may be used. In case there is a conflict 204 in preferences of the gift recipients, reconciliation 205 can be effected by two methods. In the first method, the gift buyer may state that if a conflict occurs, then the personal preference of one of the gift recipients, selected by the gift buyer, overrides conflicting interests. In the second method, the gift buyer may have the option to expose the conflict, and the conflict is resolved collectively by the gift recipients. For example, if a profile is created for a specific family, the thanksgiving or black Friday purchasing activity can be targeted at the combined interest and preferences of the family.

The reconciliation module 306 performs the reconciliation in the before mentioned paragraph. When there are contrasting inputs on preferences, the reconciliation module 306 plays a major role. For example, consider a situation wherein when a first gift recipient desires flowering plants, whereas the second gift recipient desires plants with ornamental foliage. The reconciliation module 306 will then attempt to identify ornamental foliage plants that also bloom, for example a Begonia plant. However, if a first gift recipient desires a cactus and the second gift recipient desires an orchid, the contradicting preferences cannot be reconciled by the reconciliation module. The reconciliation module 306 will put forth a question to the participants, i.e. the first and second gift recipients that they would have to reconcile amongst themselves and provide their collective (arrived via a compromise) choice to the system. The conflict resolved preferences are then applied to surface products or services for purchase 206.

The reconciliation process is described herein in detail. The reconciliation process supports collaborative preference elicitation where desired features have to be chosen individually, but group consensus is needed for them to become active. Given a set of objects and a set of user preferences, both defined over a set of categorical attributes, the Multiple Categorical Preferences (MCP) problem is to determine the objects that are considered preferable by all users. One of the main similarity metrics is the Intersection over Union (IoU) which is a classic measure of similarity between two sets. A non-parametric rank distance model performance measure is applied that counts the number of pairwise disagreements between the lists. Larger the distance, the more dissimilar the lists.

In some implementations, weightage may be allocated to different users to adjust the preference style when there are multiple decision makers. For example, consider a family including a husband, wife, children and a mother in law. They could jointly decide that the mother in law's preference may only be jointly set to 10%, while the husband and wife's preference weightage may be set at 45% each.

The method of implementation of allocating weightage to adjust the preference style when there are multiple gift recipients is described below.

Consider the case of determining the group preference for k distinct users (gift recipients) I. The space of products is approximated to be a finite dimensional vector space. The standard basis for this space is defined to be a collection of all learning units. Hence, every product can be defined uniquely using only the learning units. For every product P and every learning unit L, there exists a unique 1′ in L such that p is the intersection of all 1′. The space of all products can be approximated by the collection of all attributes. Group some attributes together and consider it as a coordinate axis on the before mentioned space. A single learning unit may be represented as a single coordinate axis on the space, and the collection of all coordinate axes represents the entire product space.

Assume n distinct learning units, L. Furthermore ∇∀l∈L ∃m distinct attributes {l₁, l₂ . . . , lₘ}. A Basket, b, is defined, to be a collection of attributes

$$b = ( )$$

where [symbol] is an attribute in learning unit [symbol] m with attribute value [symbol] . Recall above that a gift recipient's individual preference could be determined via an application of Bayes Rule. In particular, the probability that a gift recipient will click on a given product was determined. This defines a rank order over the space of Baskets, B. For any gift recipient, i∈I, define the utility function. Uᵢ,

$${U}_{i} ( b ) = \frac{P ( b )}{P ( )}$$

where, P(b), is the click probability defined before. Further define the group utility function,

$$U = {\sum }_{= 1}^{k}$$

To find the optimal basket across k gift recipients, maximize the group utility function,

$${max}_{b ∈ B} U$$

As the objective is to maximize a joint utility function, when players want to consider only a subset of the universe of baskets, first determine for each player, i, their restricted space of baskets, [symbol] ᵢ.

Consider the joint restricted space,

$$= {\prod }_{i = 1}^{k} {i}_{}$$

To find the optimal basket across k users, the group utility function on the restricted space is maximized,

$${max}_{b ∈ \tilde{B}} ⋃$$

Another situation to consider is when certain individuals in the group have more influence in the decision making process. In this case individual utility functions are weighted accordingly. Consider again the restricted space, [symbol] . We define individual weights, 0≤wᵢ≤1 and,

$${\sum }_{i = 1}^{k} {w}_{i} = 1$$

In this situation, consider the weighted joint utility function,

$${U}_{w} = {\sum }_{= 1}^{k} {w}_{} \cdot \\$$

To consider both situations of restricted baskets and variable utility solutions are determined to the following maximization equation,

$${max}_{b ∈} {U}_{w}$$

The collective preferences profile evolves on an ongoing basis by active solicitation of feedback to accommodate changing preferences and to provide the most suited recommendation at any time.

The buyer may choose to have a linked profile or a delinked profile. A delinked profile is typically applied for a defined and fixed set of attributes.

However, for a linked profile, for example linking the profiles of a husband and wife, when the husband changes their preferences, the changed preference profile is updated on the wife's account. Such an actively linked profile methodology for purchasing ensures that the active changes in the tastes and preferences of the gift recipient s are dynamically updated. Linked profiles are selectively used, and typically used where the gift recipients are in close social standing. For example, linked profiles may be used for a best friend or a spouse.

If some browsing sessions are to be conducted incognito, then the gift recipient may have the option to disable and not be engaged in the profile building activity. Hence, “active” sessions will update the profile and “incognito” sessions will not make changes to the profile. The gift recipient also has the option to choose the type of inputs that may be used to build profiles. Privacy filters may be setup beforehand by the gift recipients for select categories. Hence, even if the gift recipient were to forget to switch on the incognito mode, their earlier chosen options may still protect their privacy interests. The gift recipient may at any point delete any updated to their profile by selectively deselecting certain historical sessions.

In another embodiment, the user may create a profile and share it selectively with others, and can optionally set up a time for deactivation. For example, Emma, who is getting married, may put up her profile in a close friends group. In this manner, the close friends can use the profile for shopping for Emma, and Emma can deactivate her profile after the wedding.

If Henry wishes to link Emma's profile, and if Henry and Emma are on the sample platform, the profiles can be conveniently linked. If Henry want's Emma profile linked, Emma will have to accept an invite from Henry. The list of people who have access to a gift recipient's profile can be viewed by the gift recipient at any point in time. The gift recipient has the option to deactivate his or her own profile at any point in time.

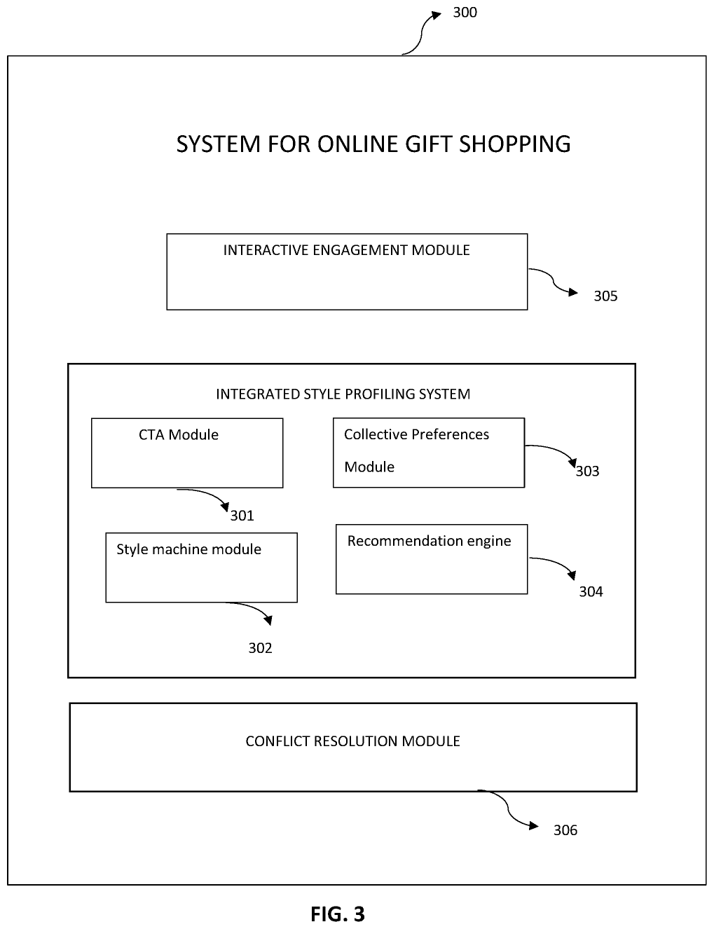

FIG. 3 illustrates a system for acquiring and utilizing individual style profiles for online gift shopping.

The system includes an IEM module 305, and an integrated style profiling system that includes a CTA module 301, a style machine module 302, a collective preferences module 303, and a recommendation engine 304. A conflict resolution module 306 is utilized to resolve conflicts between preferences of gift buyers and/or recipients.

FIG. 4 illustrates the overall system architecture for determining the product and service preferences of a gift recipient. The system architecture comprises an interactive engagement module to determine the deep attribute level and aesthetic preferences of the gift recipient(s). The integrated style profile system generates an integrated style profile of a plurality of gift recipients. The CTA module 301 presents the first user with a choice to confirm that if the plurality of gift receiver's style profile can be collectively used, and if any other user's style preferences need to be added. The style machine module 302, as a grid of products with or without an interactive engagement module, is presented to the user to engage with to provide their feedback. The collective preferences modules 303 generates a combined set of preferences. The recommendation engine 304 infers commonalities in preferences. The conflict resolution module 306 resolves conflicts in preferences amongst the plurality of gift receivers.

The processing steps described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database modules might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802. XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method of acquiring and utilizing individual style profiles for online gift shopping for a gift recipient by a gift buyer on a ecommerce website, comprising the steps of:
capturing deep attribute and aesthetic level preferences of said gift recipient via an interactive engagement module, wherein said gift recipient is exposed to both visual and textual questions; and
applying said deep attribute and aesthetic level preferences of the gift recipient to surface products for purchase by said gift buyer.

2. The computer implemented method of claim 1, wherein said gift buyer sets a budget, and said deep attribute and aesthetic level preferences of the gift recipient are utilized to surface products for purchase by the gift buyer within said budget.

3. The computer implemented method of claim 1, wherein said gift buyer enters the ecommerce website and initiates creation of a custom profile for the gift recipient and an invitation link is thereafter sent to the gift recipient.

4. The computer implemented method of claim 1, wherein said ecommerce website will provide tabs for profile capture initiation for the gift recipient.

5. The computer implemented method of claim 1, wherein the gift recipient is provided with an option via a user interface to disengage at any point during their profile building process.

6. The computer implemented method of claim 5, wherein said gift recipient disengages during their profile building process, and after said gift recipient disengages in said profile building process, a pop up is generated that states that a style profile has been generated for the gift recipient, and confirms with the gift recipient whether the style profile can be shared with the gift buyer.

7. The computer implemented method of claim 1, wherein the gift buyer is provided with an option to view the profile on the website and have the option to use the profile for a one time use and define a time period to retain the profile.

8. The computer implemented method of claim 1, wherein the style profile of the gift recipient is segmented, and the gift recipient selectively shares only certain segments of their profile.

9. The computer implemented method of claim 1, wherein when the gift recipient's profile is on active mode, product or service options presented for purchase on the website will lean towards preferences of the gift recipient, and if the gift recipient's profile is deactivated, personal preferences of the gift buyer will be activated.

10. The computer implemented method of claim 1, wherein a privacy filter is set up by said gift recipient enabling them to browse in incognito mode without enabling recording of their profile during selected sessions and wherein an act of selection of said incognito mode will not make changes to their profile during said selected sessions.

11. The computer implemented method of claim 1, wherein said gift recipient is provided with an option to selectively deselect particular historical sessions from their profile.

12. The computer implemented method of claim 1, wherein said gift recipient may create a profile and share it selectively with others, and can optionally set up a time for deactivation of a profile of said gift recipient.

13. A computer implemented method of acquiring and utilizing individual style profiles for online gift shopping for a plurality of gift recipients by a gift buyer transacting on a ecommerce website, comprising:
capturing deep attribute and aesthetic level preferences of each of the plurality of said gift recipients via an interactive engagement module, wherein said gift recipient is exposed to both visual and textual questions;
creating an integrated style profile based on identified commonalities at an attribute level and derived insights is created for use in a current session of the gift buyer; and
applying said integrated style profile of the gift recipients to surface products for purchase by said gift buyer.

14. The computer implemented method of claim 13, wherein a call to action is presented to said gift buyer to capture use of a profile of one or more gift recipients.

15. The computer implemented method of claim 13, wherein if there is a conflict in preferences of the plurality of gift recipients, reconciliation is undertaken.

16. The computer implemented method of claim 15, wherein said reconciliation is effected by the gift buyer overriding conflicting interests, and choosing one or a combination of preferences of the plurality of gift recipients.

17. The computer implemented method of claim 15, wherein the reconciliation is effected by the gift buyer exposing said conflict to the plurality of gift recipients, and the conflict is resolved collectively by the plurality of gift recipients.

18. The computer implemented method of claim 13, wherein said integrated style profile is a linked profile of gift recipients in close social standing and wherein tastes and preferences of the gift recipients are dynamically updated in said integrated style profile.

19. A system for acquiring and utilizing individual style profiles for online gift shopping for a plurality of gift recipients by a gift buyer on a ecommerce website, comprising:
at least one processor;
a non-transitory computer readable storage medium communicatively coupled to said at least one processor, said non-transitory computer readable storage medium configured to store modules, said at least one processor configured to execute said modules; and
said modules comprising:
a call to action module for generating prompts for said gift recipients to include one more other gift recipients;
a conflict resolution module for resolving contradictions between preferences of gift recipients;
a collective preferences modules module for analysing custom profiles of each of said plurality of gift recipients;
a style machine module that records each of analysed style profiles of said plurality of gift recipients, and creates an integrated style profile of the plurality of gift recipients; and
a recommendation engine for generating and presenting a curated product to be displayed to said gift buyer based on said integrated style profile.

20. The system of claim 19, wherein said resolving contradictions is effected by the gift buyer exposing conflict to the gift recipients, and said conflict is resolved collectively by the gift recipients.
